(19) United States
(12) Patent Application Publication
(10) Pub. No.: US 2011/0208851 A1
(43) Pub. Date: Aug. 25, 2011

(54) SYSTEM AND METHOD FOR DATA STORAGE, SUCH AS DISCOVERY AND MARKING OWNERSHIP OF NETWORK STORAGE DEVICES

(76) Inventor: Robin Frost, Kirkland, WA (US)

(21) Appl. No.: 13/030,997

(22) Filed: Feb. 18, 2011

Related U.S. Application Data
(60) Provisional application No. 61/307,433, filed on Feb. 23, 2010.

(51) Int. Cl. G06F 15/173

(52) U.S. Cl. 709/223

(57) ABSTRACT

A system and method for discovery and marking ownership of network storage devices discovers, marks ownership and auto-attaches persistent network storage devices using the AoE or other network storage/protocols by storing encoded data in a configuration string or other settable persistent memory of these devices.

### CROSS-REFERENCE TO RELATED APPLICATION

This application claims the benefit of the inventor's U.S. Provisional Patent Application No. 61/307,433 filed 23 Feb., 2010, incorporated herein by reference.

### BACKGROUND

Data storage networks employ many different protocols, each with different, specific parameters. For example, ATA-over-Ethernet (AOE) network storage devices have a configuration string or “config string” that is a 1024 byte string that can be set by host computers. They also have a pair of numbers called “shelf/slot.” The config string and shelf/slot numbers are discoverable by computers on the same Ethernet network through a standard broadcast protocol involving raw Ethernet packets only. AoE as a storage protocol only employs raw Ethernet packets point-to-point with MAC address endpoints (no IP numbers). AoE runs below the IP layer on a network and it does not require IP to be running on that network. If IP is running on the network, AoE devices know nothing about IP-level devices and their names, configuration, etc.

AoE is used by Linux computers and the kernel driver for the AoE protocol will often set the config string of an AoE storage device to the TCP/IP hostname of the Linux host that attaches to the AoE storage device. This allows for visual and computer inspection of the AoE device config strings to show from where they have been accessed. This hostname is not used in any other way and can change as it depends upon the IP layers above, e.g., if set by DHCP and the user who can change it manually at any time.

Prior approaches do not provide a method for marking persistent devices as such. Nor do prior approaches provide a method to discover, recognize and mount persistent devices. Users must either write scripts to run on boot or repetitively search the network at other times, thereby increasing CPU/network traffic. The hostname recorded in the AoE device config string is not used in any other way and can change, invalidating the config string, as it depends upon the IP layers above, e.g., if set by DHCP and the user who can change it manually at any time. This is unfortunate, as AoE can co-exist on networks with IP traffic but runs below IP in the network stack. Thus, dependency on any IP functionality is a bad design choice because changes in the IP naming parameters will affect AoE devices. Concomitantly, AoE cannot know when IP level changes occur because AoE knows nothing of the IP layer communications.

Prior approaches rely upon specifying unique shelf/slot numbers for all AoE devices, and then polling constantly to find each device that matches desired shelf/slots, and then attaching them once they are found'. This approach unnecessarily increases CPU and network traffic and wastes time. Using the prior approach, new devices are difficult to find and connect to the network without repeated polling.

Aspects of the invention can overcome one or more of the above problems, as well as solving other problems.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high-level network diagram conceptually illustrating a system according to principles of the invention; and

FIG. 2 is a high-level flowchart conceptually illustrating steps of a method according to principles of the invention; and

FIG. 3 is a high level network diagram conceptually illustrating a system according to another principal of the invention; and

FIG. 4 is a high-level flow chart conceptually illustrating steps of a method according to another principal of the invention; and

FIG. 5 is a high-level block diagram conceptually illustrating a system according to another principal of the invention.

Those skilled in the art will appreciate that the figures are provided to illustrate an example embodiment. They are not intended to illustrate every embodiment of the invention. The invention is not limited to the example embodiments depicted in the figures or to the types of network devices, configurations, particular sequence of steps or other specific features shown in the figures.

### DETAILED DESCRIPTION

This invention relates generally to network storage devices, such as a system and method for discovery and marking ownership of network storage devices that may be used in a variety of data processing architectures and environments. The invention has broad applicability in many other environments and network elements or resources, such as with Bluetooth and other Ethernet/WiFi devices.

To solve one or more of the problems set forth above, in a suitable implementation of the invention, a self-managing system and method for specifying multiple network devices as persistently mounted on computers and discovering and recognizing the devices easily on a network are provided. The recognized devices may be mounted automatically by their owning host computer or, in the case of shared access, by several computers. The system and method apply to any network device using any network protocol as long as that device has a configuration or other stored string that it can return when it is discovered and also has a MAC address or some type of unique end point address, e.g., an address equivalent to a MAC address such as a globally unique identifier (GUID) that is unique with respect to network(s) on which the device will be accessed.

Various examples of the invention will now be described. The following description provides certain specific details for a thorough understanding and enabling description of these examples. One skilled in the relevant technology will understand, however, that the invention may be practiced without many of these details. Likewise, one skilled in the relevant technology will also understand that the invention may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

Described in detail below is a system and methodology to mark ownership of network storage devices so that they may be persistently attached then mounted and reattached/remounted by their owning computers even after reboots. The system may be implemented in code (e.g., drivers, software, firmware) and/or hardware.

As used herein, attaching is a process of connecting a data storage device to the appropriate low level parts of the operating system so that the operating system may access the device

As used herein, mounting is the process of making a file system ready for use by the operating system, typically by reading certain index data structures from storage into memory ahead of time. The equivalent to mounting in Microsoft Windows is known as mapping a drive. Microsoft's NTFS 3 also supports Volume Mount Points through the use of NTFS reparse points, which allows volumes to be mounted at arbitrary locations in the file system in addition to the standard drive letters (e.g. C:, E:). A file system is a hierarchy of directories (also referred to as a directory tree) that is used to organize files or discrete data objects on a computer or storage media (e.g., a CD-ROM or floppy disk).

ATA-over-Ethernet (AoE) storage devices have a ‘config string’ that is a 1024 byte string. The config string can be set by host computers, and a benefit of the config string is that the AoE protocol does not specify any contents for it, and thus it may be used to provide the functions described herein. AoE was devised initially for use by Linux computers and the kernel driver for the AoE protocol will often set the config string to the TCP/IP hostname of the Linux host that attaches to the AoE device. This allows for visual and computer inspection of the read config strings to show from where they have been accessed. This (IP) hostname is not used in any other way and can change as it is dependent on the IP layers above, e.g., if set by DHCP and/or the user who can change it manually at any time. AoE drivers for other operating systems such as Windows, BSD and Solaris work substantially the same way as the Linux driver mentioned above.

The system described in detail herein uses, e.g., the config string, to automatically discover devices marked persistent and assign them to be mounted by their owning host computers without user intervention. While devices are switched off, they will simply not be discovered. Such devices will be discovered and recognized subsequently, if and when they are activated and perform their power-on broadcast. Advantageously, when devices join a network and broadcast their discovery data, a system and method according to aspects of the invention allows AoE driver software to automatically mount the devices as they become visible. As another advantage, devices that do not have ownership marked will not be auto-mounted by any host and can be manually mounted as desired

Prior approaches do not provide a method for marking a persistent device as such. Nor do prior approaches provide a method to discover, recognize and mount persistent devices. Users must either write scripts to run on boot or repetitively search the network at other times, thereby increasing CPU/network traffic. The hostname recorded in the AoE device config string is not used in any other way and can change, invalidating the config string, as it depends upon the IP layers above, e.g., if set by DHCP and the user who can change it manually at any time. This is unfortunate, as AoE can co-exist on networks with IP traffic but runs below IP in the network stack. Thus, dependency on any IP functionality is a bad design choice because changes in the IP naming parameters will affect AoE devices. Concomitantly, AoE cannot know when IP level changes occur because AoE knows nothing of the IP layer communications.

Prior approaches rely upon specifying unique shelf/slot numbers for all AoE devices, and then polling constantly to find each device that matches desired shelf/slots, and then attaching them once they are found. This approach unnecessarily increases CPU and network traffic and wastes time.

The system and method according to aspects of the invention overcome prior systems, which cannot handle the case of devices discovered with the same shelf/slot number on the same network segment. This is not forbidden by the AoE protocol standard, but is a limitation chosen voluntarily by the Linux community and then adopted by the other drivers so that they too will be unable to handle this situation. In contrast, the present system and method work in such cases, because extra information encoded in the config string allows driver software implementing the system to not care if shelf/slot numbers are the same on multiple devices. The Linux community and other software companies supporting the AoE protocol have proceeded in the opposite direction, using polling for specific devices with a shelf/slot signature and using the config string to protect against double attachment.

The system and method discovers, marks ownership and auto-attaches ‘marked’ persistent network storage devices using the AoE and other network storage/protocols by storing encoded data in the ‘configuration string’ (or other settable persistent memory) of these devices. The broadcast/discovery approach provides a non-polling, low CPU/network traffic solution to the problem, contrary to prior approaches that employ a polling approach, which wastes CPU and network bandwidth.

A system and method for discovery and marking ownership of network storage devices could also be used in other interconnection scenarios to encode the desired connections between devices and hosts. Other interconnect scenarios can include printers, Bluetooth headsets, or other Bluetooth devices such as cameras. Likewise, other interconnect scenarios can include Wi-Fi devices, such as IP or AoE web/digital cameras, music players, or any network device that needs to be recognized and owned by a host computer or mobile device. The device requires an end point identifier, such as a MAC address or even an IP address. Further, the invention is applicable other technologies, such as storage area network (SAN), which can use Fibre Channel, InfiniBand, or other protocols such as iSCSI.

The system and method may be applied to AoE and network devices configured with more than one communications interface. In the case of AoE or network devices that are reachable via two or more networks simultaneously, the system also provides a function to encode in the config string the MAC address of the preferred communications interface(s) to be utilized by the host computer to communicate with that device.

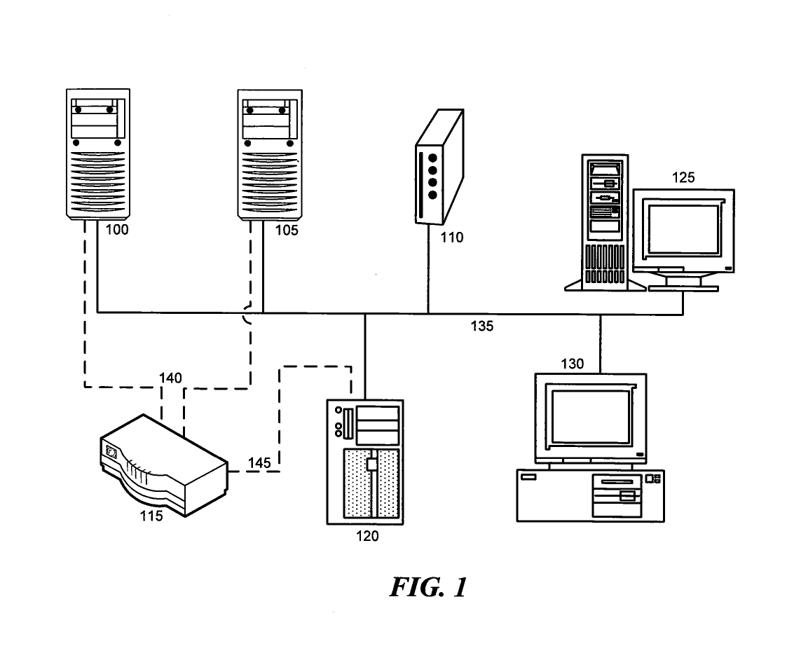

FIG. 1 and the following discussion provide a brief, general description of a suitable computing environment in which the invention can be implemented. Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules or components may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

With reference to FIG. 1, an AoE network conversation and action steps taken using an AoE RAID storage solution is conceptually illustrated. A network switch 115 (e.g., a SAN gigabit switch) is operably coupled 140 to computers 100 and 105. A network 145 (e.g., a SAN network) communicatively couples a storage device 120 (e.g., a RAID box) to the switch 115. Various other computers 125, 130, AoE disk enclosure 110 and other devices and peripherals may be operably coupled to one or more of the networks, such as LAN 135.

Via computer 100, AoE driver software broadcasts discovery. AoE packets are received by every device on the SAN network 140 and LAN 135 network (per AoEr11 Protocol Doc, section 3.2, Query Config Information). Via computer 105, AoE driver software likewise broadcasts discovery. AoE packets are again received by every device on the SAN network 140 and LAN 135 network (Per AoEr11 Protocol Doc, section 3.2, Query Config info). The AoE RAID box device replies with an information packet (“Info Packet”): Hello, here I am, my Ethernet MAC Address is 11:22:33:44, my major/minor numbers are 3/2 and my Config String is “FROST F [00:11:22:34]”. The config string can include any identifying signature, such as “FROST”, or a longer identifying string, but such a longer string may consume too many characters of the config string.

The host need not constantly poll because AoE devices broadcast the same discovery reply packets whenever they are turned on or rebooted. Further, such devices can broadcast at intervals of minutes to ensure that all hosts have recognized them on the network, but such broadcasts need not be required. When the host receives one of these packets from a device, the host will automatically attach and mount the device as described herein.

Further, a management graphical user interface (“GUI”) can show the new device to a user. In other words, hosts will perform AoE discovery, for example, on demand from the management GUI. However, because AoE devices automatically broadcast their presence when connected to the network, all the hosts also connected to that network will receive these broadcasts and automatically process them according to the methods described herein. In general, the management GUI may be any user interface provided as a software layer above the AoE driver to allow a user to add devices, display devices, or provide other functionality described herein.

In the same way that client hosts also perform AoE discovery during their boot process, so to they will discover the AoE device early, and can attach/mount them early, so that such devices are readily usable immediately, which is all that need be required to keep storage devices connected to the network and usable by hosts without constant polling. Of course, hosts can also perform extra discoveries to manage more advanced networks, such as multi-pathing to storage devices, but this may only be required on a dedicated storage network with multiple connections per host and AoE devices, and few concerns over broadcast messages. The system described herein scales well to large installations, such as those with more than 65,000 devices, partly due to the lack of constant polling.

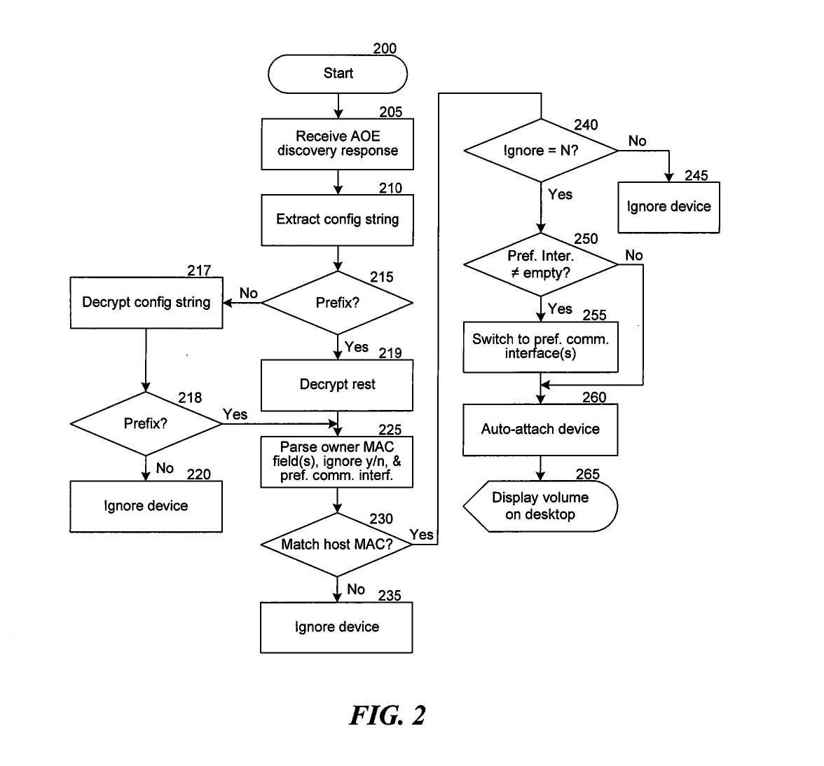

On computer 100, the AoE driver software receives the Info Packet, and parses it according to a method discussed in connection with the flowchart of FIG. 2, looking first for a recognized signature, such as, by way of example and not limitation, a particular signature (e.g. “FROST”). If it matches, then the AoE driver looks at an Ignore field which is “F” in the example above. The Ignore field follows the signature of the present system and is a true or false (T or F) or (Y or N) value. The ignore field may be preceded by a space for easy parsing by the AoE driver, but is unnecessary, or could be replaced by another character or characters. The ignore field provides, for example, a way for devices to mark themselves as offline while performing backups or file system maintenance. When the host computer or mobile device sees the signature, it knows how to deal with the included config string according to the processes described herein where the Ignore field indicates to a host computer whether to ignore the device, e.g. AoE LUN/Device. Therefore, in this example, this AoE device is not ignored. Finally it looks at the encoded MAC Address [“00:11:22:34”], which matches one of computer 100's Ethernet ports' MAC addresses. Thus, the AoE driver concludes this AoE device is MINE (i.e., owned or co-owned by computer 100) and the AoE driver then attaches and auto-mounts AoE RAID box device onto the desktop of computer 100.

Via computer 105, its AoE driver software receives the Info Packet, and parses it according to methodology of the flowchart in FIG. 2, looking first for a recognized signature, such as, by way of example and not limitation, the signature (e.g. “FROST”). If that matches, then the driver looks at the Ignore Field, which is F. Thus, the driver determines that it should not ignore this AoE device. Finally, the driver looks at the encoded MAC Address [“00:11:22:34”] which does not match any of computer 105's Ethernet ports' MAC Addresses. Thus, the AoE driver concludes this AoE device is NOT MINE and the AoE RAID BOX Device is therefore ignored by the AoE driver on this computer 105.

There is not normally a procedure for the computer to attach a device if it wanted to, because the MAC address does not match the device, and because that device is reserved by access by another computer, under this example. However, in the case of multiple read-only access or with a shared SAN file system (or other shared access environment) running on the network, the computer 105 could then add itself to a list of owners for that device, and the shared file system would handle multiple accesses. If no owner for the device exists, then the computer 105 could manually attach it using a client-side GUI, such as the management GUI and claim it temporarily for itself.

AoE disk enclosure device 110 replies to the computers 100 and 105 broadcasts with Info Packet “Hello, here I am, my Ethernet MAC Address is 00:00:88:99, my major/minor numbers are 1/1 and my Config String is “FROST F [00:11:22:35]”. On computer 100, the AoE driver software receives this Info Packet, and parses it according to the method discussed in connection with the flowchart of FIG. 2, looking first for a recognized signature, such as, by way of example and not limitation, a signature (e.g. “FROST”). If it matches, then it looks at the Ignore field which is “F”. Therefore, this AoE device is not ignored. Finally it looks at the encoded MAC Address list [“00:11:22:35”], which does not match one of computer 100's Ethernet ports' MAC addresses. Thus, the AoE driver concludes this AoE device is NOT MINE (i.e., not owned or co-owned by computer 100) and the AoE driver therefore ignore this device.

Via computer 105, an AoE driver software receives the Info Packet, and parses it according to methodology of the flowchart in FIG. 2, looking first for a recognized signature, such as, by way of example and not limitation, a signature (e.g., “FROST”). If that matches, then the driver looks at the Ignore Field, which is F. Thus, the driver determines that it should not ignore this AoE device. Finally, the driver looks at the encoded MAC Address list [“00:11:22:35”] which does match one of computer 105's Ethernet ports' MAC Addresses. Thus, the AoE driver concludes this AoE device is MINE (i.e., owned or co-owned by computer 105) and the AoE driver then attaches and auto-mounts e.g., “AoE Disk Enclosure Device #1” onto the desktop.

The config string may be set up to have ownership encoded in it. In many cases, the config string will be set up by GUI management software for an AoE target device. The config string for a logical unit number (LUN) AoE device can also be set up remotely using functionality under the AoE protocol.

In some cases, the host computers, mobile devices or other data processing devices can set the config string of unclaimed AoE devices to mark ownership of those devices for the host computers or mobile devices, or add themselves to an existing group of hosts/mobile devices already included in the config string. This option of allowing host computer/mobile devices to add themselves to an existing group of hosts already encoded in the config string may be useful, for example, for shared access work groups or server groups, thereby making use of networked storage simple. In an enterprise network (described below), it may be preferable to not allow hosts to claim AoE devices for themselves.

Referring now to the flowchart of FIG. 2, a process 200 starts when AoE driver software on a host receives an AoE discovery Ethernet packet from an AoE device, as in block 205. Such a packet may have been received in response to a broadcast discovery message sent by the host under the AoE protocol. The Ethernet packet received includes config string data and two integers for the shelf and slot which are extracted as data in block 210.

The following steps are performed either by the AoE driver or by a combination of the AoE Driver and application-level code. We will refer to just the “driver” performing these steps for simplicity.

The config string may be encrypted wholly or partially. In the partial case, Case 1, the first part of the config string, the signature (e.g. “FROST”) may optionally be in plaintext, with the rest of the config string encrypted. This provides the option that third-party software may recognize the device as being controlled/managed by certain software (e.g., the AoE driver software) and so ignore the device.

To provide system administrators with maximum security, as an alternative the entire config string may be encrypted, Case 2, so that no hint is given regarding the scheme or software that is managing this device.

In block 215 the driver tests first for a known unencrypted plaintext signature at the beginning of the config string (e.g. “FROST”). If one is recognized, Case 1, then the rest of the config string is decrypted in block 219 by applying one of several algorithms. These may include a symmetric cipher such as RC4, Blowfish or AES with a shared secret between the driver and the AoE device. Having decrypted the rest of the config string, control proceeds from block 219 to block 225.

For the other case, where no known unencrypted plaintext signature is detected at the beginning of the config string, the driver assumes Case 2 that the config string is wholly encrypted or is unencrypted and does not match. The entire config string is then decrypted in block 217 by applying one of several algorithms. These may include a symmetric cipher such as RC4, Blowfish or AES with a shared secret between the driver and the AoE device.

The driver then tests in block 218 again for a known signature at the beginning of the config string. If one is recognized, then the device belongs to the driver and control passes to block 225. Otherwise control passes to block 220, where the device is ignored.

In block 225, the Ignore field, device owner MAC address list field, and Preferred Interface fields are parsed in the following manner:

The Ignore field is a true or false (T or F or Y or N) in the config string following the signature.

Next the device owner MAC address list field is a field of the form [aa:bb:cc:dd, . . . ] where aa:bb:cc:dd is a MAC address and this field can contain one or more MAC addresses as denoted by the “, . . . ” in the field description.

Next the Preferred Interface MAC address field is a field of the form [ee:ff:gg:hh, . . . ] where ee:ff:gg:hh is a MAC address and this field can contain one or more MAC addresses as denoted by the “, . . . ” in the field description.

If one or more of the device owner MAC address(es) matches one of the host's Ethernet or WiFi port addresses (or other addresses) then step 230 passes control to step 240. Otherwise control passes to step 235, where the device is ignored.

If the ignore field is “N” then step 240 passes control to step 250. Otherwise control passes to step 245, where the device is ignored. The ignore field provides, for example, a way for devices to mark themselves as offline while performing backups or file system maintenance.

If the Preferred Interface list field is empty, [ ] or blank then step 250 passes control to step 260.

In step 260, the device is auto-attached which is a step undertaken by the operating system making the device ready for use.

If the preferred interface list field is non-empty, then in step 255 the driver switches to the preferred Ethernet interface(s) for communication with the device, if specified. The preferred interface list field may be a list of MAC addresses, represented in square brackets such as [aa:bb:cc:dd, . . . ]. This list represents interfaces on a target server that it wishes clients to use when accessing a particular LUN/device. In the case of a target server with many Ethernet port connections to a network, this allows the target to specify a subset of the ports to be used for multi-pathing to a LUN device, which can provide high availability and fail-over features. Such functionality can be used in higher-end devices and/or high-availability devices within business or enterprise applications.

Then the driver auto-attaches, in step 260.

Finally, the device volumes appear on the desktop in block 265 as the operating system mounts the device (MAC, Linux, Unix) or maps the device to a drive (Windows).

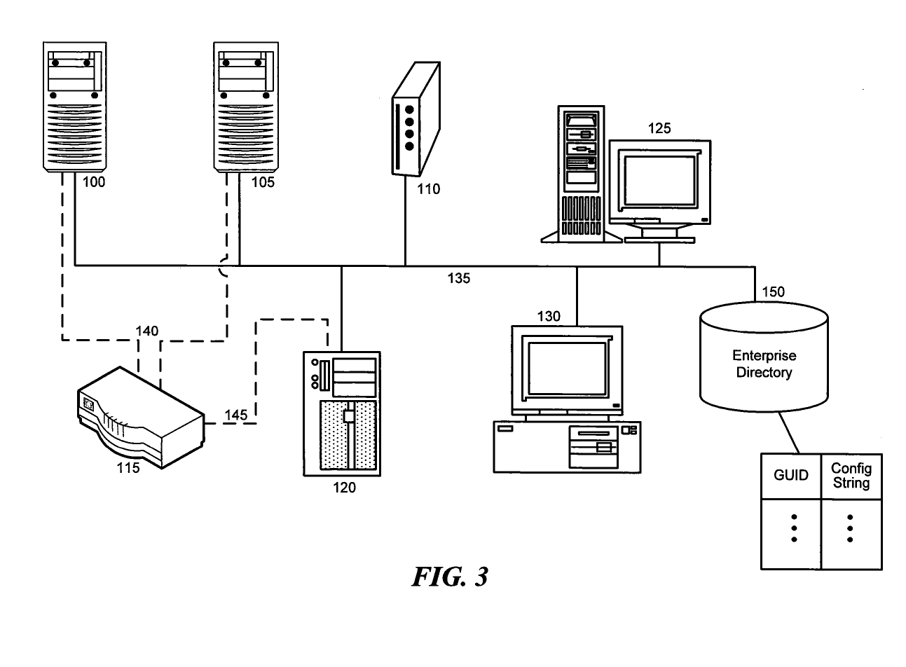

Many alternative implementations of the invention are of course possible. For example, FIG. 3 shows an example of the system integrated into enterprise directory services. FIG. 3 is similar to FIG. 1, but includes an enterprise directory 150 or database that has stored therein a table or other data structure that maps globally unique identifiers (GUID) to config strings. As a result, the computer 100, 105, or other host computer or mobile device broadcasts AoE discovery packets in the same manner as described herein. The AoE network devices return a config string consisting of the signature, followed by a single GUID. The computer or mobile device looks up this GUID in the enterprise directory 150 to retrieve the associated device config string, formatted as described above. The host computer or mobile device then uses the returned config string as described below. This approach allows integration of the system with an enterprise directory infrastructure, rather than storing the config string directly on devices.

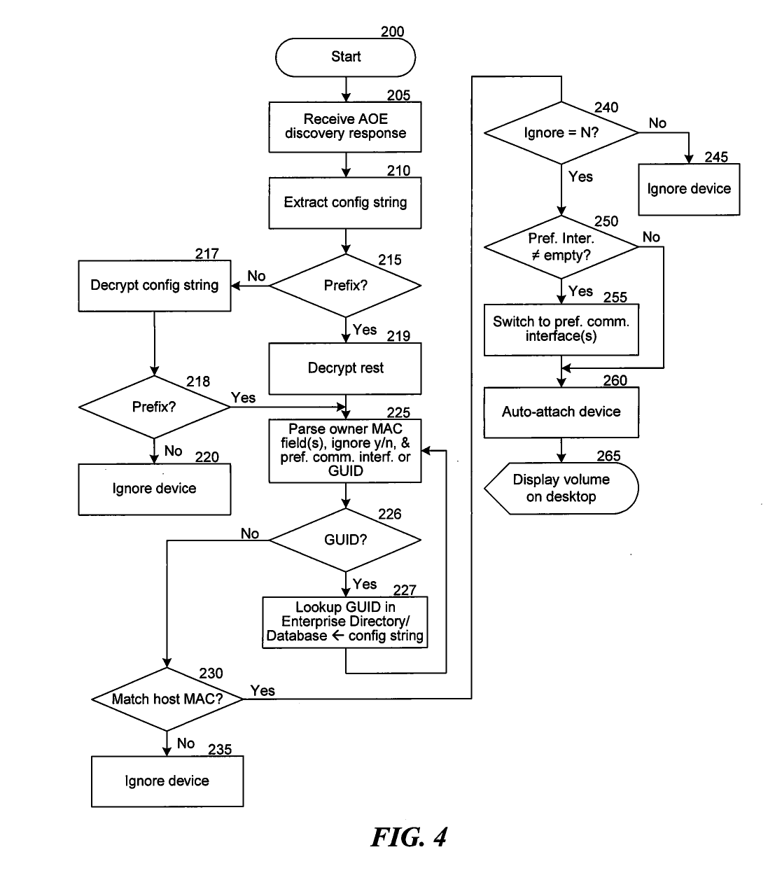

Referring to FIG. 4, an example of a process, similar to process 200 of FIG. 2 is shown. Under this alternative, the system in block 225 parses any received response to identify if it includes any GUID. If not, then in block 227, the system looks up the GUID in the enterprise directory/database, and retrieves the associated config string. Otherwise, the process of FIG. 4 is substantially similar to that of FIG. 2.

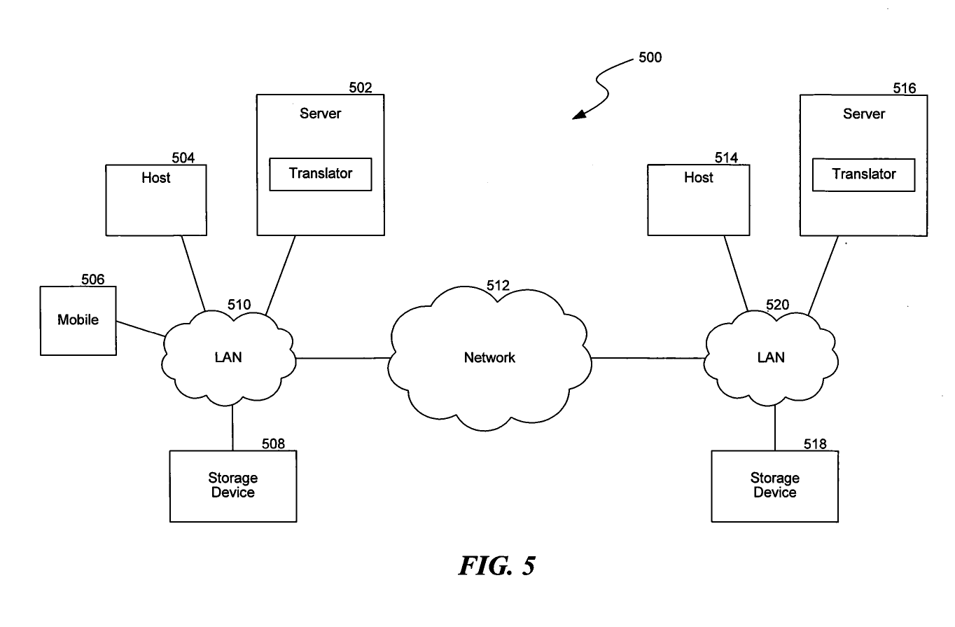

Further alternative or additional implementations of the invention are of course possible. For example, the invention may be used across IP networks for providing AoE storage across IP networks. Referring to FIG. 5, an example of a system 500 includes a server 502, host 504, mobile device 506 and storage device 508 coupled to a LAN 510. Of course, additional, or fewer, devices may be coupled to the LAN, and the LAN may instead be any network, such as a WAN, WLAN, etc. The LAN 510 is in turn coupled to a network 512, which can be an IP network, the Internet, or other network. The network 512 is also coupled to a second host 514, second server 516, second storage device 518, via a second LAN 520.

In this example, the host computers and mobile devices 504, 506 can perform the AoE discovery as described above. The server, running an AoE translator, encapsulates the AoE discovery packets into UDP (or TCP/IP) packets and sends them across the network 512 to the second LAN 520. The entire Ethernet AoE discovery packet is encapsulated or wrapped as the data payload in a UDP or TCP packet. This makes it easy for the AoE translator at the receiving end to extract the AoE discovery packet. It then has the information it needs to translate local AoE discovery replies to be sent back to the original network's AoE translator. While the translator is shown as running on a separate server, some or all aspects of the translator could also be embedded in the host 504 and/or mobile device 506.

The second server 516 receives the UDP (or TCP/IP) packets and, via its corresponding AoE translator, converts the UDP (OR TCP/IP) packets into AoE packets to transmit on the second LAN 520. The second network can then discover local AoE network devices (such as second storage device 518, etc.). The server 516 receives discovery reply packets via the second LAN 520, wraps these inside one or more UDP (or TCP/IP) packets, and returns the UDP (or TCP/IP) packets over the network 512 to the original AoE translator of the server 502.

In response, the server 502 translates the received UDP (or TCP/IP) packets and extracts the AoE discovery packet data from those received UDP (or TCP/IP) packets. The AoE translator at the server 502 sends the AoE discovery reply packets on the LAN 510, back to the host 504 and/or mobile device 506, which originally performed the AoE discovery broadcast. The host computer 504 or mobile device 506 can then interpret the AoE discovery reply packet as described above.

Under this system 500, a mechanism for hosts and devices across the network 512, such as the Internet, allows hosts and mobile devices to transparently discover devices, and interact with each other, as noted above. Further, the AoE translators at the servers 502, 516 also translate and route normal AoE read/write packets between the two locations (where the locations are defined by the two LANs 510, 520). In this way, the system thereby provides a way to expand AoE network storage to larger Internet-accessible storage devices and volume mount points.

The AoE translator at Location A then extracts the AoE discovery packet data from the UDP (OR TCP/IP) packets received. The AoE translator at Location A sends AoE discovery reply packets on its local network back to the host computer or mobile device that originally performed the AoE discovery broadcast. The host computer or mobile device then interprets the AoE discovery reply packet per the Invention.

This provides the mechanism for hosts and devices across the Internet to transparently discover and interact with each other per the Invention.

As additional information, the AoE translators at Locations A and B also translate and route the normal AoE read/write packets between the locations so providing a way to expand AoE network storage to the larger Internet.

Skilled artisans will appreciate that a system and method according to principles of the invention simplify management of network storage devices, reduce time consumed by IT staff managing network storage devices, and decrease network traffic relating to recognition and mounting of network storage devices, thereby increasing return on investment for storage devices and infrastructure. Conserved CPU time and network bandwidth improves overall efficiency.

Systems and methods according to principles of the invention may be applied to data storage solutions, such as LAN and SAN storage devices, for consumer, small and medium size business and enterprise markets.

Described in detail above is a system and associated method to automatically discover and mark or identify ownership of network storage devices that provides for the automatic attachment of owned network devices to one or more end host computers and/or mobile devices such as laptops, tablets, and Smart phones.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for”, but use of the term “for” in any other context is not intended to invoke treatment under 35 U.S.C. §112, ¶6.) Accordingly, the applicant reserves the right to pursue additional claims after filing this application to pursue such additional claim forms, in either this application or in a continuing application.

I/We claim:

1. A system for discovery and mounting of data storage devices coupled to a network, comprising:
a requesting host computer coupled to the network,
wherein the host computer includes a unique electronic network address, and
wherein the host computer employs driver software configured to transmit a broadcast request over the network; and,
at least one storage device coupled to the network,
wherein the storage device is configured to reply with a predefined reply packet after receiving the broadcast message,
wherein the predefined reply packet includes a data string stored on the storage device, and
wherein the data string includes a unique electronic address for the storage device; and,
wherein the host computer, receiving the predefined reply packet, directly or indirectly compares the unique electronic address to the unique electronic network address, and
if the unique electronic address matches the unique electronic network address, then the host computer attaches and mounts the data storage device.

2. The system of claim 1 wherein the broadcast message is an ATA over Ethernet (AoE) message, and wherein the predefined reply packet includes a MAC address for the storage device and a config string, wherein the config string includes a signature or identifier, a true/false ignore field, and the unique electronic network address, wherein the unique electronic network address is an Ethernet or WiFi port MAC address.

3. The system of claim 1 wherein the host computer, after receiving the predefined reply packet, decrypts either a prefix of the predefined reply packet, or all of the predefined reply packet, before parsing the predefined reply packet to analyze the data string.

4. The system of claim 1 wherein the predefined reply packet includes a preferred interface list field, wherein the preferred interface list field is either empty or includes one or more MAC addresses that represent interfaces on the storage device that the host computer can use to accesses a particular logical unit number (LUN) for the storage device.

5. The system of claim 1 wherein the unique electronic address of the predefined reply packet is a globally unique identifier (GUID), and wherein the host computer indirectly compares the unique electronic address to the unique electronic network address by first accessing a database using the GUID to obtain a stored data string, wherein the database stores a data structure that maps GUIDs to corresponding stored data strings.

6. The system of claim 1 wherein the network includes an internet protocol (IP) network,
wherein the broadcast message is an ATA over Ethernet (AoE) message, wherein the host computer provides the broadcast request to a translator,
wherein the translator encapsulates the broadcast request in a user datagram protocol (UDP) or transmission control protocol (TCP) packet before sending the UDP or TCP packet over the IP network to the storage device, and
wherein the storage device receives the UDP or TCP packet,
wherein the storage device includes another translator that converts the received UDP or TCP packet back into the ATA message, and
wherein the other translator encapsulates the predefined reply packet into another UDP or TCP packet before sending the other UDP or TCP packet over the IP network to the host computer.

7. The system of claim 1 wherein the host computer is a mobile device, and wherein the storage device is a storage area network (SAN) storage device, an ATA over Ethernet (AoE) disk drive, or a RAID box.

8. A method for discovery of data storage devices coupled to a network, comprising:
at a requesting host computer coupled to the network, transmitting a broadcast request over the network,
wherein the host computer includes a unique electronic network address;
receiving from a storage device coupled to the network, a predefined reply packet in response to the broadcast message,
wherein the predefined reply packet comprises a data string including a unique electronic address for the storage device;
directly or indirectly comparing the unique electronic address in the received predefined reply packet to the unique electronic network address; and,
if the unique electronic address matches the unique electronic network address, then mounting the data storage device to the host computer to permit the host computer to read from and write to the storage device.

9. The method of claim 8 wherein the broadcast message is an ATA over Ethernet (AoE) message, and wherein the predefined reply packet includes a MAC address for the storage device and a config string, wherein the config string includes a signature or identifier, a true/false ignore field, and the unique electronic network address, wherein the unique electronic network address is an Ethernet or WiFi port MAC address.

10. The method of claim 8, further comprising: after receiving the predefined reply packet, decrypting either a prefix of the predefined reply packet, or all of the predefined reply packet, before parsing the predefined reply packet to analyze the data string, and wherein the host computer is a mobile device.

11. The method of claim 8 wherein the predefined reply packet includes a preferred interface list field, wherein the preferred interface list field is either empty or includes one or more MAC addresses that represent interfaces on the storage device that the host computer can use to accesses a particular logical unit number (LUN) for the storage device.

12. The method of claim 8 wherein the unique electronic address of the predefined reply packet is a globally unique identifier (GUID), and wherein the method further comprises: indirectly comparing the unique electronic address to the unique electronic network address by accessing a database using the GUID to obtain a stored data string, wherein the database stores a data structure that maps GUIDs to corresponding stored data strings.

13. The method of claim 8 wherein the network includes an internet protocol (IP) network,
wherein the broadcast message is an ATA over Ethernet (AoE) message, wherein the host computer provides the broadcast request to a translator,
wherein the translator encapsulates the broadcast request in a user datagram protocol (UDP) or transmission control protocol (TCP) packet before sending the UDP or TCP packet over the IP network to the storage device, and
wherein the storage device receives the UDP or TCP packet,
wherein the storage device includes another translator that converts the received UDP or TCP packet back into the ATA message, and
wherein the other translator encapsulates the predefined reply packet into another UDP or TCP packet before sending the other UDP or TCP packet over the IP network to the host computer.

14. A non-transitory computer-readable medium storing a method that, when executed by a data processing devices, performs discovery of network devices coupled to a network, the method comprising:
transmitting a broadcast request over the network;
receiving from a network device coupled to the network, a predefined reply packet in response to the broadcast message,
wherein the predefined reply packet comprises a data string including a unique electronic address for the network device;
directly or indirectly comparing the unique electronic address in the received predefined reply packet to a unique electronic network address; and,
if the unique electronic address matches the unique electronic network address, then attaching or connecting to the network device.

15. The computer-readable medium of claim 14 wherein the broadcast message is an ATA over Ethernet (AoE) message, and wherein the predefined reply packet includes a MAC address for the storage device and a config string, wherein the config string includes a signature or identifier, a true/false ignore field, and the unique electronic network address, wherein the unique electronic network address is an Ethernet or WiFi port MAC address.

16. The computer-readable medium of claim 14, further comprising: after receiving the predefined reply packet, decrypting either a prefix of the predefined reply packet, or all of the predefined reply packet, before parsing the predefined reply packet to analyze the data string.

17. The computer-readable medium of claim 14 wherein the predefined reply packet includes a preferred interface list field, wherein the preferred interface list field is either empty or includes one or more MAC addresses that represent interfaces on the storage device that the host computer can use to accesses a particular logical unit number (LUN) for the storage device.

18. The computer-readable medium of claim 14 wherein the unique electronic address of the predefined reply packet is a globally unique identifier (GUID), and wherein the method further comprises: indirectly comparing the unique electronic address to the unique electronic network address by accessing a database using the GUID to obtain a stored data string, wherein the database stores a data structure that maps GUIDs to corresponding stored data strings.

19. The computer-readable medium of claim 14 wherein the network includes an internet protocol (IP) network,
wherein the broadcast message is an ATA over Ethernet (AoE) message, wherein the host computer provides the broadcast request to a translator,
wherein the translator encapsulates the broadcast request in a user datagram protocol (UDP) or transmission control protocol (TCP) packet before sending the UDP or TCP packet over the IP network to the storage device, and
wherein the storage device receives the UDP or TCP packet,
wherein the storage device includes another translator that converts the received UDP or TCP packet back into the ATA message, and
wherein the other translator encapsulates the predefined reply packet into another UDP or TCP packet before sending the other UDP or TCP packer over the IP network to the host computer.

20. The computer-readable medium of claim 14 wherein the host computer is a mobile device, and wherein the storage device is a storage area network (SAN) storage device, an ATA over Ethernet (AoE) disk drive, or a RAID box.

21. A system to perform discovery of network devices coupled to a network, the system comprising:
means for transmitting a broadcast request over the network;
means for receiving from a network device coupled to the network, a predefined reply packet in response to the broadcast message,
wherein the predefined reply packet comprises a data string including a unique electronic address for the network device;
means for directly or indirectly comparing the unique electronic address in the received predefined reply packet to a unique electronic network address; and,
means for attaching or connecting to the network device if the unique electronic address matches the unique electronic network address.
